(19) United States
(12) Patent Application Publication
(10) Pub. No.: US 2013/0162805 A1
(43) Pub. Date: Jun. 27, 2013

(54) IMAGE PROCESSING APPARATUS, IMAGE PROCESSING SYSTEM, IMAGE PROCESSING METHOD, AND PROGRAM FOR PROCESSING A VIRTUAL SLIDE IMAGE

(71) Applicant: CANON KABUSHIKI KAISHA, Tokyo (JP)

(72) Inventor: Tomohiko Takayama, Tokyo (JP)

(73) Assignee: CANON KABUSHIKI KAISHA, Tokyo (JP)

(21) Appl. No.: 13/717,579

(22) Filed: Dec. 17, 2012

(30) Foreign Application Priority Data
Dec. 27, 2011 (JP) 2011-286782

(51) Int. Cl. H04N 7/18

(52) U.S. Cl. 348/80

(57) ABSTRACT

An image processing apparatus includes a data acquisition unit configured to acquire data of a virtual slide image, and a display control unit configured to display the virtual slide image and a plurality of annotations added to the virtual slide image on a display apparatus, wherein data pieces of the plurality of annotations include diagnostic criterion information of the plurality of annotations, respectively, and the display control unit groups at least two of the plurality of annotations based on the diagnostic criterion information, causes display forms of the plurality of annotations to differ from each other based on the diagnostic criterion information, and displays the plurality of annotations on the virtual slide image.

### BACKGROUND OF THE INVENTION

1. Field of the Invention

The present invention relates to an image processing apparatus, an image processing system, an image processing method, and a program for processing a virtual slide image.

2. Description of the Related Art

A virtual slide system has been popularized which can acquire a virtual slide image by imaging a sample on a slide with a digital microscope, and can display and observe the virtual slide image on a monitor (see Japanese Patent Application Laid-Open No. 2011-118107).

In addition, a document management apparatus capable of discriminating generators of annotations added to document data from each other has been discussed (see Japanese Patent Application Laid-Open No. 11-25077).

Diagnostic criteria and diagnostic classifications are updated as needed and are not unified among countries or areas. When a user views a sample diagnosed according to an old diagnostic criterion again or confirms a sample of another country based on the different diagnostic criterion for study, which diagnostic criterion is used for contents of an annotation described as a basis of the diagnosis may not be determined.

### SUMMARY OF THE INVENTION

The present invention relates to an image processing apparatus capable of easily determining an annotation added according to a different diagnostic criterion.

According to an aspect of the present invention, an image processing apparatus includes a data acquisition unit configured to acquire data of a virtual slide image, and a display control unit configured to display the virtual slide image and a plurality of annotations added to the virtual slide image on a display apparatus, wherein data pieces of the plurality of annotations include diagnostic criterion information of the plurality of annotations, respectively, and wherein the display control unit groups at least two of the plurality of annotations based on the diagnostic criterion information, causes display forms of the plurality of annotations to differ from each other based on the diagnostic criterion information, and displays the plurality of annotations on the virtual slide image.

In the image processing apparatus according to the aspect of the present invention, when an annotation is added, not only the contents of the annotation itself but also diagnostic criterion information are stored together and a correspondence relation therebetween is prepared as a list. Therefore, the diagnostic criterion can easily be identified when the annotation is indicated.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an entire configuration of an image processing system utilizing an image processing apparatus according to an exemplary embodiment of the present invention.

FIG. 2 is a functional block diagram illustrating an imaging apparatus in the image processing system utilizing the image processing apparatus according to the exemplary embodiment.

FIG. 3 is a functional block diagram illustrating the image processing apparatus according to the exemplary embodiment.

FIG. 4 illustrates a hardware configuration of the image processing apparatus according to the exemplary embodiment.

FIG. 5 is a flowchart illustrating a flow of addition and indication of an annotation in the image processing apparatus according to the exemplary embodiment.

FIG. 6 is a flowchart illustrating a detailed flow of addition of an annotation in the image processing apparatus according to the exemplary embodiment.

FIG. 7A illustrates a basic structure of a screen layout of a display apparatus according to the exemplary embodiment. FIG. 7B illustrates an example of an operation screen, when an annotation is added according to the exemplary embodiment. FIG. 7C illustrates an example of screen display, when an annotation is indicated according to the exemplary embodiment.

FIG. 8A illustrates an example of a diagnostic criterion setting screen of the image processing apparatus according to the exemplary embodiment. FIG. 8B illustrates an example of a diagnostic classification screen of the image processing apparatus according to the exemplary embodiment. FIG. 8C illustrates an example of a warning screen of the image processing apparatus according to the exemplary embodiment.

FIG. 9 illustrates an example of a structure of annotation data managed by the image processing apparatus according to the exemplary embodiment.

FIG. 10 illustrates an example of a diagnostic classification correspondence screen of the image processing apparatus according to the exemplary embodiment.

FIG. 11A illustrates a diagnostic environment of a user according to the exemplary embodiment. FIG. 11B illustrates an electronic medical record according to the exemplary embodiment.

### DESCRIPTION OF THE EMBODIMENTS

Various exemplary embodiments, features, and aspects of the invention will be described in detail below with reference to the drawings.

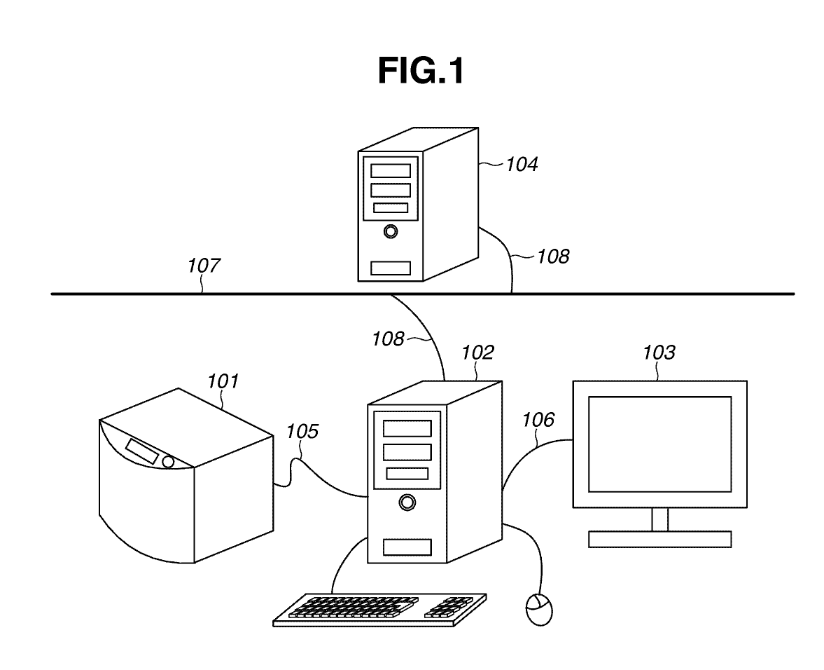

An image processing apparatus according to an exemplary embodiment of the present invention can be used in an image processing system that includes an imaging apparatus and a display apparatus. The image processing system will be described with reference to FIG. 1.

FIG. 1 illustrates the image processing system utilizing the image processing apparatus according to the present exemplary embodiment. The image processing system has a function for acquiring and displaying a two-dimensional image of a sample to be imaged. The image processing system includes an imaging apparatus (a microscope device or a virtual slide scanner) 101, an image processing apparatus 102, a display apparatus 103, and a data server 104. The imaging apparatus 101 and the image processing apparatus 102 are connected to each other by a dedicated or general-purpose interface (I/F) cable 105. The image processing apparatus 102 and the display apparatus 103 are connected to each other by a general-purpose I/F cable 106. The data server 104 and the image processing apparatus 102 are connected to each other via a network 107 by a general-purpose interface local area network (I/F LAN) cable 108.

The imaging apparatus 101 is a virtual slide apparatus that captures a plurality of two-dimensional images having different positions in a two-dimensional plane direction and outputs digital images. When the two-dimensional images are acquired, a solid-state image sensor such as a charge coupled device (CCD) or a complementary metal oxide semiconductor (CMOS) is used. Instead of the virtual slide apparatus, the imaging apparatus 101 maybe configured by a digital microscope device in which a digital camera is mounted on an eyepiece portion of a general optical microscope.

The image processing apparatus 102 is an apparatus that has, for example, a function for generating data to be displayed on the display apparatus 103 from a plurality of original image data pieces acquired from the imaging apparatus 101 based on the original image data in response to a request from a user. The image processing apparatus 102 is configured by a general-purpose computer or a workstation that includes hardware resources such as a central processing unit (CPU), a random access memory (RAM), a storage device, an operation unit, and various I/Fs. The storage device is a large-capacity information storage device such as a hard disk drive. The storage device stores programs or data pieces to be used to realize each process to be described below, an operating system (OS), and the like. Each function described above is realized, when the CPU loads a necessary program and data in the RAM from the storage device and executes the program. The operation unit includes a keyboard or a mouse and is used for an operator to input various instructions.

The display apparatus 103 displays an observation image which is an arithmetic operation result of the image processing apparatus 102 and includes a cathode-ray tube (CRT) or a liquid crystal display.

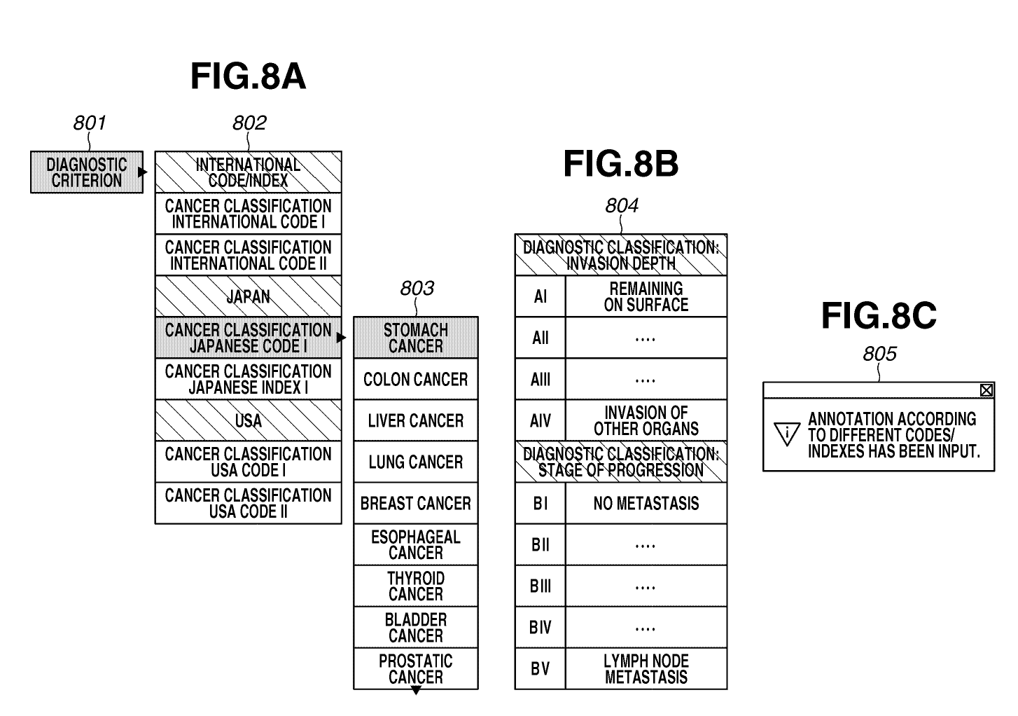

The data server 104 stores diagnostic criterion information (data relevant to a diagnostic criterion) serving as a guideline, when a user diagnoses a sample. The diagnostic criterion information is updated as needed to be suitable for the current situation of a pathological diagnosis. The data server 104 updates the storage contents according to the update of the diagnostic criterion information. The diagnostic criterion information will be described below with reference to FIGS. 8A to 8C.

In the example in FIG. 1, four devices of the imaging apparatus 101, the image processing apparatus 102, the display apparatus 103, and the data server 104 are included in the imaging system, however the exemplary embodiment of the present invention is not limited to this configuration. For example, an image processing apparatus integrated with a display apparatus may be used or the functions of the image processing apparatus may be embedded in the imaging apparatus. Further, the functions of the imaging apparatus, the image processing apparatus, the display apparatus, and the data server may be realized by one device. Conversely, the functions of the image processing apparatus and the like may be divided and realized by a plurality of devices.

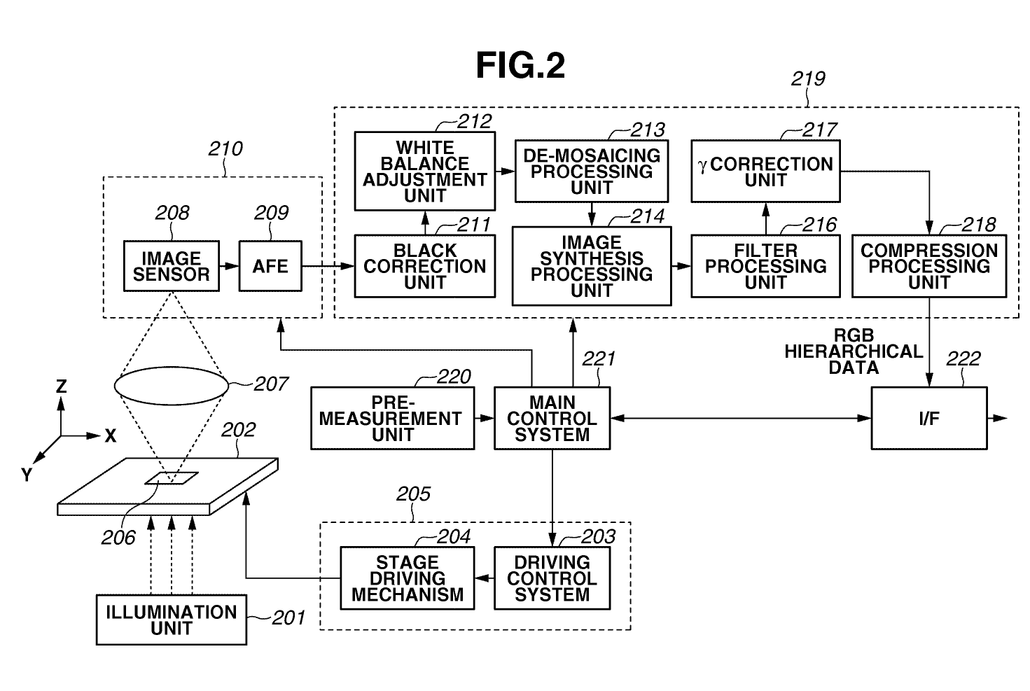

FIG. 2 is a block diagram illustrating a functional configuration of the imaging apparatus 101.

The imaging apparatus 101 generally includes an illumination unit 201, a stage 202, a stage control unit 205, an imaging optical system 207, an imaging unit 210, a development processing unit 219, a pre-measurement unit 220, a main control system 221, and a data output unit 222.

The illumination unit 201 uniformly illuminates a slide 206 disposed on the stage 202 with light. The illumination unit 201 includes a light source, an illumination optical system, and a light source driving control system. The driving of the stage 202 is controlled by the stage control unit 205, and thus the stage 202 can be moved in three-axis directions of XYZ. The slide 206 is a member on which a segment of a tissue or a smeared cell to be observed is attached onto a slide glass and which is fixed below a cover glass along with a mounting medium.

The stage control unit 205 includes a driving control system 203 and a stage driving mechanism 204. The driving control system 203 receives an instruction of the main control system 221 and controls the driving of the stage 202. A movement direction, a movement amount, and the like of the stage 202 are determined based on position information and thickness information (distance information) of a sample measured by the pre-measurement unit 220, and an instruction from a user, as necessary. The stage driving mechanism 204 drives the stage 202 in response to an instruction of the driving control system 203.

The imaging optical system 207 is a lens unit that forms an optical image of a sample of the slide 206 to the image sensor 208.

The imaging unit 210 includes an image sensor 208, an analog front end (AFE) 209. The image sensor 208 is a one-dimensional or two-dimensional image sensor that changes a two-dimensional optical image into an electrical physical amount through photoelectric conversion. For example, a CCD or CMOS device is used. The one-dimensional image sensor can acquire a two-dimensional image by performing scanning in a scan direction. The image sensor 208 outputs an electrical signal having a voltage value corresponding to the intensity of light. When a color image is desired as a captured image, for example, a single-plate image sensor on which a color filter with a Bayer array is mounted may be used. The imaging unit 210 captures divided images of the sample by driving the stage 202 in the XY-axis direction.

The AFE 209 is a circuit that converts an analog signal output from the image sensor 208 into a digital signal. The AFE 209 includes a horizontal/vertical (H/V) driver, a correlated double sampling (CDS), an amplifier, an analog-to-digital (AD) converter, and a timing generator to be described below.

The H/V driver converts a vertical synchronization signal and a horizontal synchronization signal for driving the image sensor 208 into potentials necessary to drive the sensor. The CDS is a correlated double sampling circuit that removes noise of a fixed pattern. The amplifier is an analog amplifier that adjusts a gain of an analog signal from which the noise is removed by the CDS. The AD converter converts an analog signal into a digital signal. When an output of the final stage of the imaging apparatus is 8 bits, the AD converter converts an analog signal into digital data for which 10 bits are quantized to about 16 bits in consideration of processing in a subsequent stage, and output the digital data. The converted sensor output data is referred to as RAW data. The RAW data is developed by the development processing unit 219 of the subsequent stage. The timing generator generates a signal for adjusting the timing of the image sensor 208 and the timing of the development processing unit 219 of the subsequent stages.

When a CCD sensor is used as the image sensor 208, the AFE 209 is an essential unit. However, when a CMOS image sensor capable of outputting digital data is used, the function of the AFE 209 described above is included in the sensor. Although not illustrated, an imaging control unit that controls the image sensor 208 is provided to perform operation control of the image sensor 208 such as a shutter speed, a frame rate, a region of interest (ROI), and an operation timing.

The development processing unit 219 includes a black correction unit 211, a white balance adjustment unit 212, a de-mosaicing processing unit 213, an image synthesis processing unit 214, a filter processing unit 216, a γ correction unit 217, and a compression processing unit 218. The black correction unit 211 performs a process for subtracting black correction data obtained from each pixel of the RAW data at the time of shielding light. The white balance adjustment unit 212 performs a process of reproducing a desirable white color by adjusting the gain of each color of red, green and blue (RGB) according to the color temperature of the light from the illumination unit 201. More specifically, white balance correction data is added to the RAW data subjected to the black correction. When a monochromatic image is treated with, a white balance adjusting process is not necessary.

The de-mosaicing processing unit 213 performs a process for generating image data of each color of RGB from the RAW data with the Bayer array. The de-mosaicing processing unit 213 calculates the value of each color of RGB of a target pixel by interpolating values of periphery pixels (including a pixel of the same color and pixels of different colors) of the RAW data. The de-mosaicing processing unit 213 performs a process (interpolation process) for correcting a defective pixel. When the image sensor 208 does not include a color filter and can obtain a monochromatic image, a de-mosaicing process is not necessary.

The image synthesis processing unit 214 performs a process for generating large-capacity image data in a desired imaging range by joining image data pieces divided in an imaging range and acquired by the image sensor 208. In general, since a sample presence range is larger than the imaging range acquired through one imaging operation by an existing image sensor, one piece of two-dimensional image data is generated by joining the divided image data pieces. For example, when it is assumed that an image in a range of 10 mm square on the slide 206 is captured with a resolution of 0.25 μm, the number of pixels of one side is 40 thousand pixels of 10 mm/0.25 μm, and thus a total number of pixels is 1.6 billion pixels which are the square of the 40 thousand pixels. In order to acquire image data of 1.6 billion pixels using the image sensor 208 having the number of the pixels of 10 M (10 million), it is necessary to perform imaging by dividing the imaging range into 160 regions of 1.6 billion/10 million.

As a method for joining a plurality of pieces of image data, a method for joining image data pieces by adjusting positions based on the position information of the stage 202, a method for joining image data pieces by joining points or lines which correspond with each other in the plurality of divided images, and a method for joining based on the position information of the divided image data pieces can be used. When the joining is performed, the image data pieces can be smoothly joined together through interpolating processing such as 0-order interpolation, linear interpolation, or higher-order interpolation. According to the present exemplary embodiment, it is assumed that one piece of large-capacity image is generated. However, as the function of the image processing apparatus 102, the divided and acquired images may be joined to each other when display data is generated.

The filter processing unit 216 is a digital filter that realizes suppression of a high-frequency component contained in an image, removal of noise, and emphasis of sharpness.

The γ correction unit 217 performs processing for adding reverse-characteristics to an image according to gradation expression characteristics of a general display device or performs gradation conversion to be suitable for the human visual characteristics through gradation compression of a high luminance portion or dark-portion processing. According to the present exemplary embodiment, in order to acquire an image for the purpose of morphological observation, gradation conversion suitable for synthesizing processing or displaying processing in the subsequent stage is applied to the image data.

The compression processing unit 218 performs compression encoding processing which is performed to efficiently transmit large-capacity two-dimensional image data and reduce the capacity of the large-capacity two-dimensional image data to be stored. As a method for compressing a still image, a standard encoding scheme such as the Joint Photographic Experts Group (JPEG), the JPEG2000 improved and advanced from the JPEG, the JPEG XR is generally and widely known.

The pre-measurement unit 220 performs preliminary measurement to calculate parameters for light quantity adjustment originated from position information of a sample on the slide 206, distance information up to a desired focal position, and a thickness of a sample. Imaging can be performed without waste by causing the pre-measurement unit 220 to acquire information before the main measurement (acquisition of captured image data). When the position information of a two-dimensional plane is acquired, a two-dimensional imaging sensor with a resolution lower than that of the image sensor 208 is used. The pre-measurement unit 220 comprehends the position of a sample on the XY plane from the acquired image. When the distance information and the thickness information are acquired, a laser displacement meter or a Shack-Hartmann measuring device is used.

The main control system 221 has a function for controlling the various units described above. The control functions of the main control system 221 and the development processing unit 219 are realized by a control circuit that includes a CPU, a ROM, and a RAM. More specifically, a program and data are stored in the ROM, and the functions of the main control system 221 and the development processing unit 219 are realized by causing the CPU to execute the program using the RAM as a work memory. For example, a device such as an electrically erasable and programmable read only memory (EEPROM) or a flash memory is used as the ROM. For example, a dynamic random access memory (DRAM) device such as double data rate 3 (DDR3) is used as the RAM. The function of the development processing unit 219 may be substituted with a unit configured by an application specific integrated circuit (ASIC) as a dedicated hardware device.

The data output unit 222 is an interface configured to transmit RGB color images generated by the development processing unit 219 to the image processing apparatus 102. The imaging apparatus 101 and the image processing apparatus 102 are connected to each other by an optical communication cable. Alternatively, a general-purpose interface such as a Universal Serial Bus (USB) or a Gigabit Ethernet (registered trademark) is used.

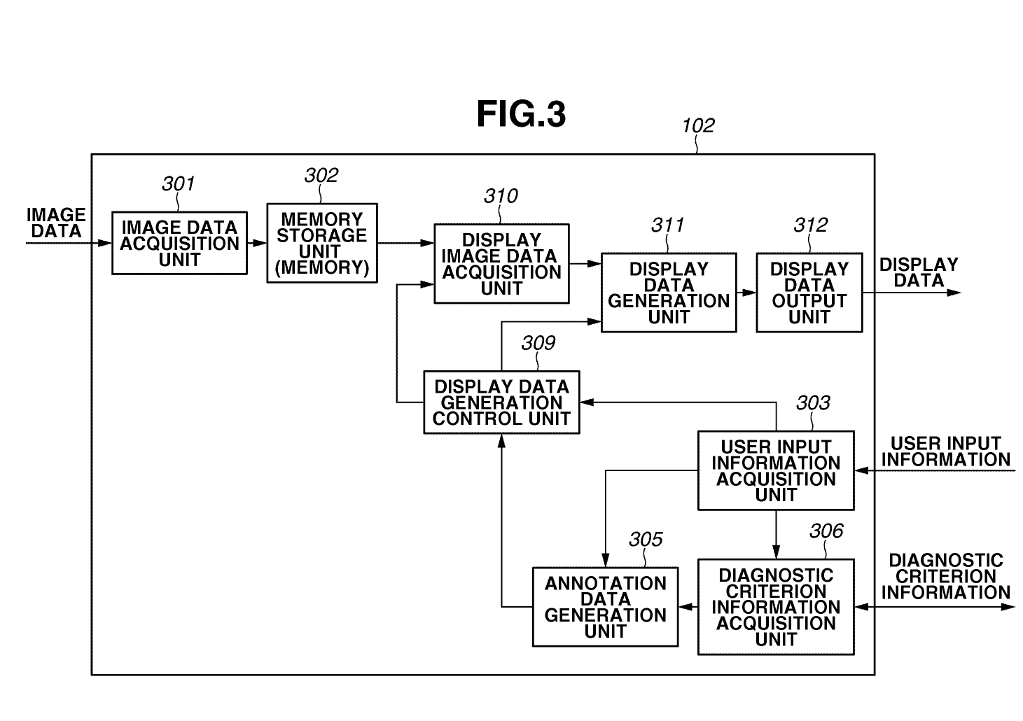

FIG. 3 is a block diagram illustrating a functional configuration of the image processing apparatus 102 according to the present exemplary embodiment.

The image processing apparatus 102 includes an image data acquisition unit 301, a memory storage unit (memory) 302, a user input information acquisition unit 303, an annotation data generation unit 305, a diagnostic criterion information acquisition unit 306, a display data generation control unit 309, a display image data acquisition unit 310, a display data generation unit 311, and a display data output unit 312.

The image data acquisition unit 301 acquires image data captured by the imaging apparatus 101. The image data described here refers to at least one of divided image data pieces of RGB colors obtained by dividing and imaging a sample and one piece of two-dimensional image data obtained by synthesizing the divided image data pieces. The divided image data pieces may be monochromatic image data.

The memory storage unit 302 imports, records, and stores image data acquired from an external device via the image data acquisition unit 301.

The user input information acquisition unit 303 acquires via the operation unit such as a mouse or a keyboard, an instruction to update display image data such as display position change or expansion or reduction display, or information to be input to a display application used at the time of performing diagnosis such as addition of an annotation. Further, the user input information acquisition unit 303 acquires an instruction to acquire diagnostic criterion information from a user.

The diagnostic criterion information acquisition unit 306 acquires the diagnostic criterion information serving as a guideline for a user who performs diagnosis from the data server 104. Since the latest diagnostic criterion information is stored in the data server 104, the corresponding diagnostic criterion information is acquired by a diagnostic criterion information acquisition instruction from a user. The diagnostic criterion information will be described below with reference to FIGS. 8A to 8C.

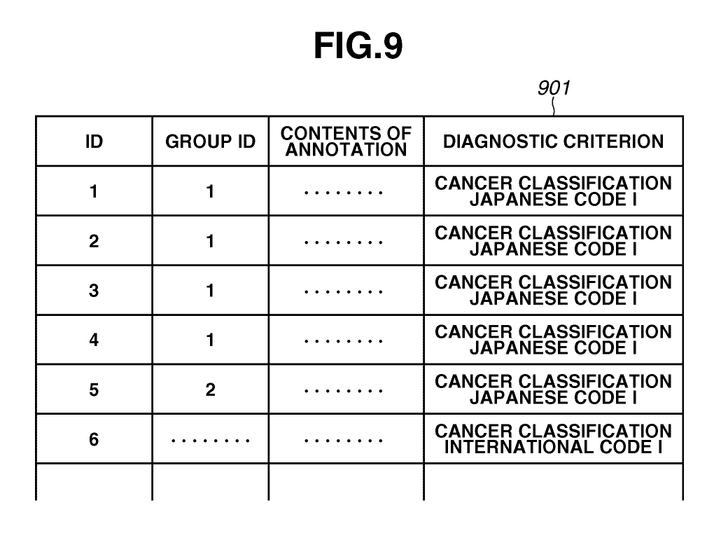

The annotation data generation unit 305 generates, as a list, text input information added as an annotation obtained by the user input information acquisition unit 303 and the diagnostic criterion information acquired by the diagnostic criterion information acquisition unit 306. A structure of the list will be described below with reference to FIG. 9.

The display data generation control unit 309 corresponds to a display control unit that controls generation of the display data in response to a user's instruction acquired by the user input information acquisition unit 303. The display data is mainly formed by the image data and annotation display data.

The display image data acquisition unit 310 acquires the image data necessary for display from the memory storage unit 302 under the control of the display data generation control unit 308.

The display data generation unit 311 generates the display data to be displayed on the display apparatus 103 based on an annotation data list generated by the annotation data generation unit 305 and the image data acquired by the display image data acquisition unit 310.

The display data output unit 312 outputs the display data generated by the display data generation unit 311 to the display apparatus 103 which is an external device.

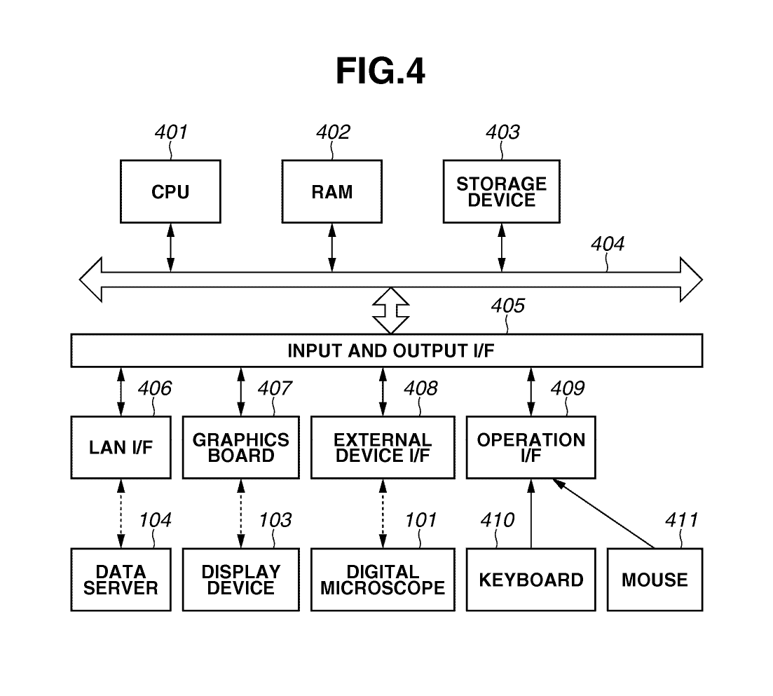

FIG. 4 is a block diagram illustrating a hardware configuration of the image processing apparatus according to the present exemplary embodiment. For example, a personal computer (PC) is used as a device that performs information processing. The PC includes a central processing unit (CPU) 401, a random access memory (RAM) 402, a storage device 403, a data input and output I/F 405, and an internal bus 404 connecting these units to each other.

The CPU 401 appropriately accesses the RAM 402 or the like, as necessary, and comprehensively control all of the blocks of the PC while performing various arithmetic operations. The RAM 402 is used as a work area or the like of the CPU 401 and temporarily stores an OS, various programs in progress, and various types of data which is an object of processing such as generation of display data. The storage device 403 is an auxiliary storage device that records and reads information fixedly stores the OS and firmware such as a program and various parameters to be executed by the CPU 401. A magnetic disk drive such as hard disk drive (HDD) or a solid-state disk (SSD) or a semiconductor device using a flash memory is used as the storage device 403.

The data server 104 is connected to the data input and output I/F 405 via the LAN I/F 406. The display apparatus 103 is connected to the data input and output I/F 405 via a graphics board. The imaging apparatus 101 is connected to the data input and output I/F 405 via an external device I/F 408. A keyboard 410 or a mouse 411 is connected to the data input and output I/F 405 via an operation I/F 409.

The display apparatus 103 may include, for example, a liquid crystal or an electro-luminescence (EL) display device. The display apparatus 103 is assumed to be connected as an external device, however it may be assumed that a PC is integrated with a display apparatus. For example, a notebook type PC corresponds to such a configuration.

A pointing device such as the keyboard 410 or the mouse 411 is assumed as a connection device with the operation I/F 409. However, a screen of the display apparatus 103 may be configured as a direct input device, such as a touch panel. In this case, the touch panel may be integrated with the display apparatus 103.

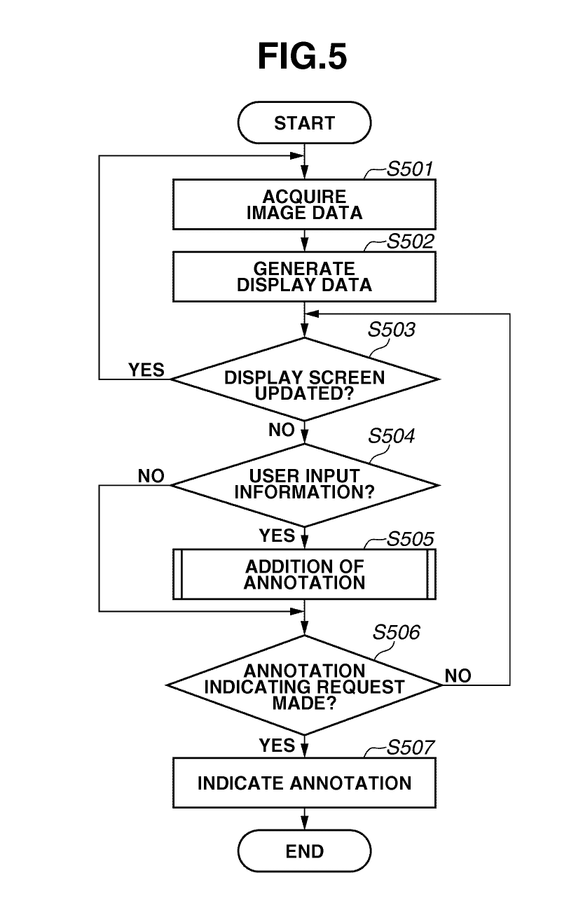

A processing flow of addition and indication of an annotation in the image processing apparatus according to the exemplary embodiment will be described with reference to a flowchart in FIG. 5.

In step S501, image data to be displayed on the display apparatus is acquired from the memory storage unit 302.

In step S502, display data to be displayed on the display apparatus 103 is generated based on the acquired image data. The generated display data is displayed on the display apparatus 103.

In step S503, it is determined whether a screen displayed in response to an instruction from a user is updated. More specifically, update of the screen includes, for example, a change in a display position to display the image data located outside the displayed screen. If it is necessary to update the screen (YES in step S503), the processing returns to step S501, and then the processing for updating the screen is performed via the acquisition of the image data and the generation of the display data. It a screen update request is not received (NO in step S503), the processing proceeds to step S504.

In step S504, it is determined whether an instruction or a request to add an annotation is received from a user. If the instruction to add the annotation is received (YES in step S504), the processing proceeds to step S505. Whereas, if the instruction to add the annotation is not received (NO in step S504), the processing for adding the annotation is skipped, and the processing proceeds to step S506.

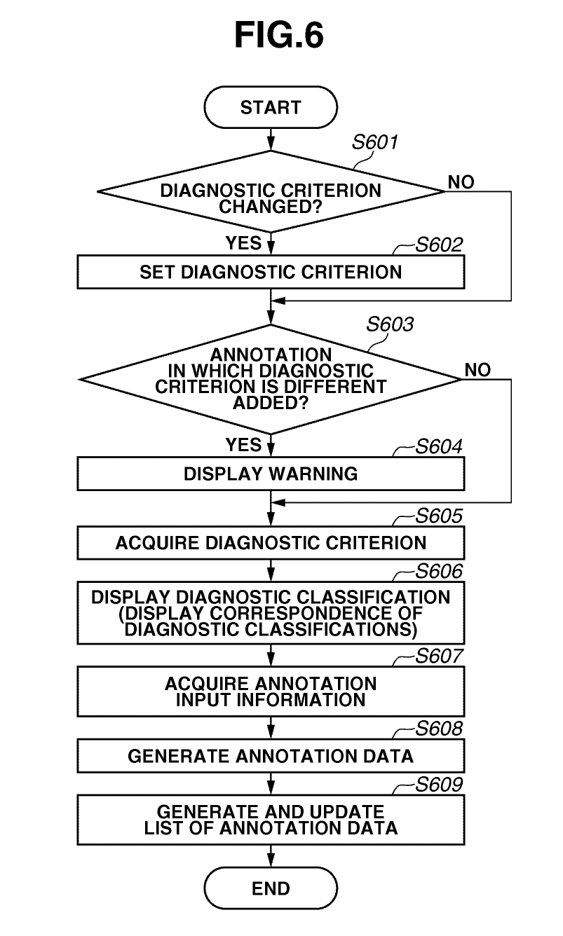

In step S505, various types of processing associated with the addition of the annotation are performed. As the processing contents, for example, storage of the contents of the annotation input using the keyboard 410 or the like, linking the contents of the annotation with the diagnostic criterion information which is the characteristic feature of the present exemplary embodiment, and displaying a warning when the annotation is added according to different diagnostic criterion. The details of the processing contents will be described below with reference to FIG. 6.

In step S506, it is determined whether a request for indicating the added annotation is made. If the request for indicating the annotation is made from the user (YES in step S506), the processing proceeds to step S507. Whereas, if the request is not made (NO in step S506), the processing returns to step S503, and the subsequent processing is repeated. The processing flow is chronologically described. However, reception of the screen update request which is the change in the display position, the addition of the annotation, and the indication of the annotation may be performed at any timing, for example, simultaneously or sequentially.

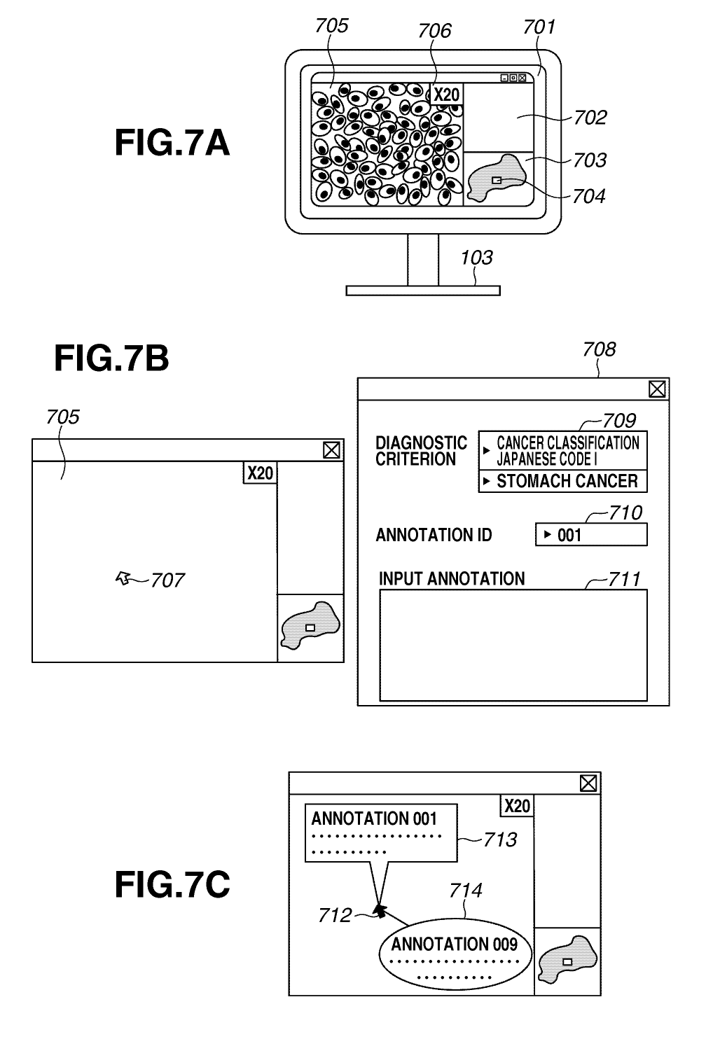

In step S507, processing for effectively indicating the annotation to the user is performed in response to the indication request. The details of the processing in step S507 will be described below with reference to FIG. 7C.

The addition of the annotation and the indication of the annotation are thus performed according to the above-described processing flow.

FIG. 6 is a flowchart illustrating the detailed processing flow for adding the annotation in step S505 in FIG. 5. The processing flow of generating annotation data based on the contents of the annotation and the diagnostic criterion information will be described with reference to FIG. 6.

In step S601, it is determined whether a diagnostic criterion is changed. If the diagnostic criterion is changed (YES in step S601), the processing proceeds to step S602. Whereas, if the diagnostic criterion is not changed (NO instep S601), the processing proceeds to step S603 while skipping step S602. A situation in which the diagnostic criterion is not changed includes a case in which the diagnostic criterion is not necessary to be changed from an initial setting when an annotation is first added. A situation in which the diagnostic criterion is changed includes a case in which a user views a sample diagnosed according to an old diagnostic criterion again and a case in which a user confirms a sample of another country according to a different diagnostic criterion for study.

The diagnostic criterion is established by collecting diagnostic classifications of respective organs and is in line with the current conditions of each country and area. The diagnostic classification indicates a stage of disease of each organ. For example, in a case of a stomach cancer, a diagnostic classification defined by a cancer classification code α which is a diagnostic criterion of a given area may be different from a diagnostic classification defined by a cancer classification code β which is a diagnostic criterion of another area. The diagnostic criterion and the diagnostic classification will be described below with reference to FIGS. 8A to 8C.

In step S602, the diagnostic criterion is set. The diagnostic criterion is set according to the current conditions of a user such as an area where the user makes a diagnosis, or suggestion of a community to which the user belong.

In step S603, it is determined whether the addition of the annotation based on the different diagnostic criterion is performed on the same sample. If the addition of the annotation is performed based on the different diagnostic criterion (YES in step S603), the processing proceeds to step S604. Whereas, if the addition of the annotation is performed based on the same diagnostic criterion (NO in step S603), the processing proceeds to step S605 while skipping step S604.

In step S604, a warning is displayed for the addition of the annotation based on the different diagnostic criterion to the same sample. (I.e., when an annotation based on a second diagnostic criterion, which is different from a first diagnostic criterion, is input to a virtual slide image to which an annotation based on the first diagnostic criterion is added, the warning is displayed on the display apparatus.) The display of warning will be described below with reference to FIG. 8C.

In step S605, diagnostic criterion information is acquired. Since the diagnostic criterion information updated according to the current situation of pathological diagnosis is stored in the data server 104, the image processing apparatus 102 acquires the diagnostic criterion set by the user in step S602 from the data server 104.

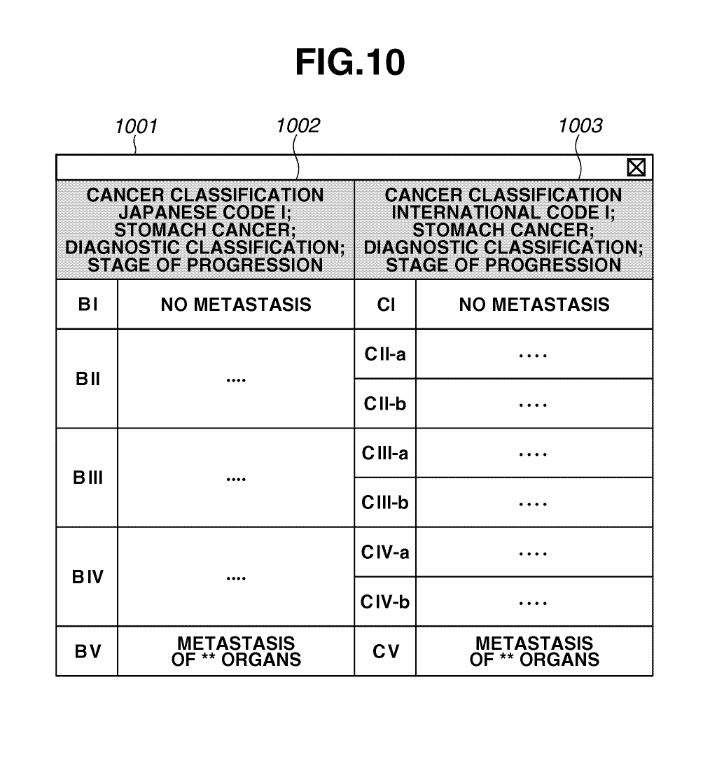

In step S606, the diagnostic classification according to the diagnostic criterion is displayed. When it is determined in step S603 that the addition of the annotation is performed on the same sample based on the different diagnostic criterion, correspondence of the diagnostic classification is displayed in response to an instruction from the user. (I.e., when an annotation based on the second diagnostic criterion, which is different from the first diagnostic criterion, is input to a virtual slide image to which an annotation based on the first diagnostic criterion is added, the correspondence of the diagnostic classifications between the first diagnostic criterion and the second diagnostic criterion is displayed on the display apparatus.) The display of the correspondence of the diagnostic classifications will be described below with reference to FIG. 10.

In step S607, the contents of the annotation input with the keyboard 410 are acquired. The acquired text information is used when the annotation is indicated.

In step S608, annotation data is generated based on the diagnostic criterion set in step S602 and the text information input as the annotation acquired in step S607.

In step S609, if the addition of the annotation is performed for the first time based on the annotation data generated in step S608, an annotation data list is newly generated. If the annotation data list is already present, values and contents of the list are updated. Information to be stored in the list is the diagnostic criterion information and the text information input as the annotation. The structure of the annotation data list will be described below with reference to FIG. 9.

The addition of the annotation and the generation of the annotation data are performed according to the above-described processing flow.

FIGS. 7A to 7C illustrate examples of display screens, when the display data generated by the image processing apparatus 102 according to the present exemplary embodiment is displayed on the display apparatus 103. A display screen for adding an annotation and a display screen for indicating an annotation will be described with reference to FIGS. 7A to 7C.

In FIG. 7A, a basic structure of a screen layout of the display apparatus 103 is illustrated. An information area 702 which indicates a status of display or an operation and information about various images, a sample thumbnail image 703 of an observation object, and a display area 705 of sample image data for detailed observation are displayed within an entire window 701. A detailed display area 704 indicating a detailed observation area displayed in the display area 705 is displayed in the sample thumbnail image 703. A display magnification 706 of the display area 705 is displayed in the display area 705. Each area and image may be configured such that the display areas of the entire window 701 is divided into each function area by a single document interface, or may be configured such that areas are displayed with separate windows by multi-document interfaces.

The sample thumbnail image 703 displays a position or a size of the display area 705 of the sample image data in the entire image of the sample. The position or the size of the display area 705 can be comprehended by a frame of the detailed display area 704. The detailed display area 704 can be set directly by a user's instruction from an input device such as a touch panel or the mouse 411 connected to the outside and can be set and updated in response to an operation for moving, enlarging, or reducing the display area of the displayed image. The sample image data for detailed observation is displayed in the display area 705 of the sample image data. In the display area 705, an enlarged or reduced image of the image is displayed by moving the display area (i.e., selecting and moving a partial area to be observed in the entire sample image) or changing the display magnification in response to an operation and instruction from a user.

In FIG. 7B, an example of an operation screen when an annotation is added is illustrated. In the image displayed in the display area 705, the user selects an interest area or a position and adds and inputs annotation information. An annotation may be added, when a position is designated with a mouse pointer, transition to an annotation input mode is performed, and a text is input with the keyboard 410. In FIG. 7B, a state is illustrated in which a mouse cursor is determined at a position 707 and a window 708 for inputting annotation information is opened. A diagnostic criterion set in advance is displayed in a text box 709, and an annotation identification (ID) which is automatically assigned is displayed in a text box 710. With regard to the contents of the annotation, a necessary comment is input to a text box 711 using an input device such as the keyboard 410. At that time, text information about the addition of the annotation and the diagnostic criterion are paired and acquired by the image processing apparatus 102.

In FIG. 7C, an example of a screen display when the annotation is indicated is illustrated. Here, an example in which two annotations are added at one place is illustrated. A point 712 indicates a point to which the annotation is added. Annotations 713 and 714 indicating contents thereof are displayed on the virtual slide image. The annotations 713 and 714 are annotations each added based on different diagnostic criteria. According to the present exemplary embodiment, a display form of the contents of the annotation is changed for each piece of information based on the different diagnostic criteria. For example, in the annotations 713 and 714, a color, a line type, or a shape of a speech balloon frame may be changed. In addition, a color, luminance, or a font of a text may be changed. Alternatively, transmittance or a background color may be changed. Further, one of the annotations may be displayed by blinking or highlighting. As a user's use form of an annotation, it can be considered that an explanation which is a basis of diagnosis is input. Therefore, there is a probability that the contents of the annotations may be different if the annotations added to the same place are based on the different diagnostic criteria. Accordingly, each annotation is displayed by changing a method of expression in order to draw a user's attention to that the diagnostic criterion is different for each annotation.

FIGS. 8A to 8C illustrate examples of a diagnostic criterion setting screen, a diagnostic classification screen, and a warning screen.

In FIG. 8A, an example of the diagnostic criterion setting screen is illustrated. For example, it is assumed that the diagnostic criterion can be changed and set through a menu operation on the entire window 701. As the diagnostic criteria, cancer classification international code I and cancer classification international code II are illustrated as the international code and international index, cancer classification Japanese code I and cancer classification index I are illustrated as the Japanese code and index, and cancer classification USA index I and cancer classification USA index II are illustrated as the USA code and index. The cancer classification Japanese code I is classified according to organs, such as stomach cancer, colon cancer, liver cancer, lung cancer, breast cancer, esophageal cancer, thyroid cancer, bladder cancer, and prostatic cancer. A diagnostic criterion 801, a list of the code and index 802, and a list of the code and index 803 for organs are indicated through the menu operation. FIG. 8A illustrates a case in which a user selects the diagnostic criterion, the cancer classification Japanese code I, and the stomach cancer through the menu operation.

In FIG. 8B, an example of the diagnostic classification screen is illustrated. A diagnostic classification 804 of the stomach cancer in the cancer classification Japanese code I is broadly classified into two parts, an invasion depth and a stage of progression. The invasion depth is an index that indicates how much stomach cancer reaches a stomach wall and is classified into four stages, AI to AIV. The classification includes contents such as the stage AI represents that the stomach cancer remains on the surface of the stomach, and the stage AIV represents that the stomach cancer invades other organs. The stage of progression is an index that indicates how mach the stomach cancer metastasizes and is classified into five stages, BI to BV. The classification includes contents such as the stage BI represents that there is no metastasis of the stomach cancer, and the stage BV represents that lymph node metastasis occurs. When stomach cancer is diagnosed according to the cancer classification Japanese code I, the invasion depth and the stage of progression are diagnosed based on information such as a sample image. The diagnostic classification 804 may be displayed in the information area 702 or a separate window, and a user can operate to display or hide the diagnostic classification 804, as necessary.

The diagnostic criterion and the diagnostic classification illustrated in FIGS. 8A and 8B are updated as needed and are not unified among countries or areas. According to the present exemplary embodiment, a user can simply determine which diagnostic criterion that the contents of an annotation described as a basis of the diagnosis are based on when the user views a sample diagnosed based on the old diagnostic criterion again or confirms a sample of another country based on the different diagnostic criterion for study.

FIG. 8C is an example of a warning screen which is displayed when an annotation based on the different diagnostic criterion is added to a sample. The warning screen is displayed to warn a user that the annotation is added to a given sample based on the different diagnostic criterion. Accordingly, the user can avoid adding an annotation based on the different diagnostic criterion which the user does not intend to apply. Further, when the user intentionally adds an annotation based on the different diagnostic criterion, the warning screen can clearly remind the user of the intention.

FIG. 9 illustrates a structure of an annotation data list generated by the image processing apparatus 102 according to the present exemplary embodiment.

In FIG. 9, the annotation data list is illustrated. In the list, as illustrated in FIG. 9, an ID number is assigned in the order that the annotation is added, and contents of the annotation and the diagnostic criterion are stored together. A group ID is information that indicates the annotation based on the same diagnostic criterion. Since ID1 and ID2 are the annotations based on the same diagnostic criterion, ID1 and ID2 are grouped to the same group ID. The main contents stored in the list of the annotation data are illustrated, however, other information pieces may be stored. Further, the list may have a structure which allows a user to add an item uniquely defined by the user to list.

Since the structure of the annotation data list includes the group ID, an expression method of indicating an annotation can be changed and displayed for each group ID.

FIG. 10 illustrates an example of a screen for a diagnostic classification correspondence. When an annotation is added based on the different diagnostic criterion or when an annotation based on the different diagnostic criterion is confirmed with respect to a given sample image, a correspondence relation between the diagnostic criteria is indicated to the user.

A diagnostic classification correspondence 1001 indicates a correspondence between the stage of progression (1002) of stomach cancer of the cancer classification Japanese code I and the stage of progression (1003) of stomach cancer of the cancer classification international code I. The stage of progression 1002 is classified into five stages, BI to BV. On the other hand, the stage of progression 1003 is classified into eight stages, CI to CV. The stage BII is further classified into stages CII-a and CII-b. Likewise, the stage BIII is further classified into stages CIII-a and CIII-b, and the stage BIV is further classified into stages CIV-a and CIV-b. The diagnostic classification correspondence 1001 may be displayed in the information area 702 or a separate window, and a user can operate to display or hide the diagnostic classification correspondence 1001, as necessary.

The diagnostic classification correspondence screen is not limited to this example. With regard to two diagnostic criteria that do not clearly have a correspondence relation, a text sentence may be displayed to inform the user of that fact. Alternatively, only a difference in the diagnostic criteria which requires special attention may be extracted and displayed in a text sentence.

Accordingly, when a user performs diagnosis based on the different diagnostic criterion or the user confirms a sample diagnosed based on the different diagnostic criterion, the user can easily comprehend the correspondence relation.

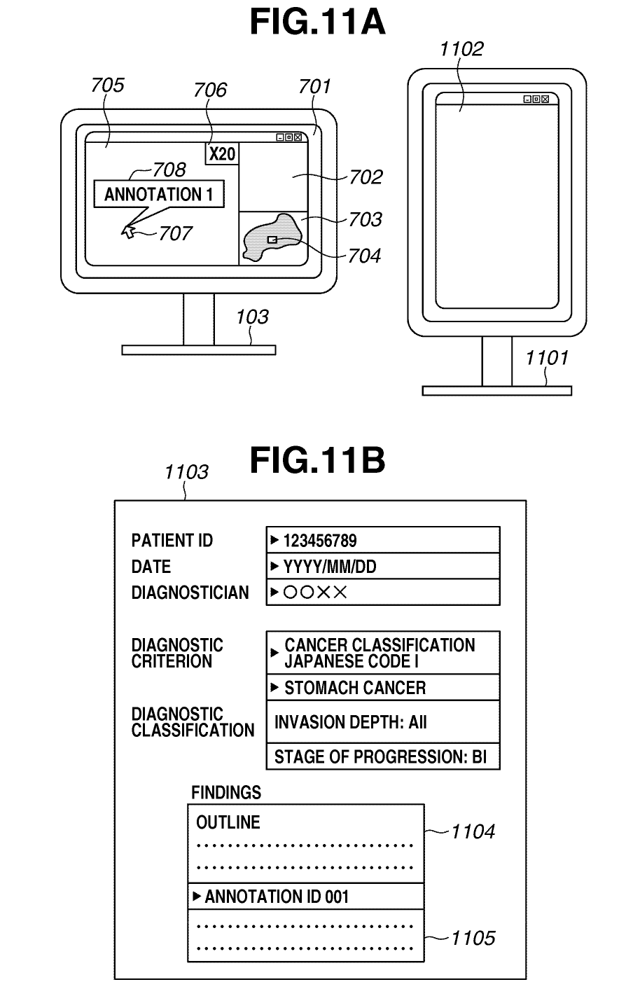

FIGS. 11A and 11B illustrate linkage with an electronic medical record of the image processing apparatus 102 according to the present exemplary embodiment. In FIGS. 7A to 7C, the example is illustrated in which the addition of the annotation or the indication of the annotation is displayed on the display apparatus 103 for indicating a sample image. On the other hand, in FIGS. 11A and 11B, an example is illustrated in which a display apparatus 1101 for indicating electronic medical record information in which diagnosis is written is provided in addition to the display apparatus 103, and annotation information displayed on the display apparatus 103 is linked with the electronic medical record information (for example, findings information) displayed on the display apparatus 1101. Items similar to those in those in FIGS. 7A to 7C are denoted with the same reference numerals, and descriptions thereof are omitted.

In FIG. 11A, a diagnostic environment of a user is illustrated in which the display apparatus 103 for indicating a sample image and the display apparatus 1101 for indicating an electronic medical record are included. The display apparatus 1101 is configured to indicate an electronic medical record in which diagnosis is written and include a display area 1102 of the electronic medical record. A user observes pathological change portions in the sample image one by one and writes diagnosis integrally with information about the pathological change portions in the electronic medical record. A note for the information obtained by observing the pathological change portions in the sample image one by one corresponds to the addition of the annotation.

In FIG. 11B, an example of an electronic medical record 1103 is illustrated. The electronic medical record 1103 includes a patient ID, a diagnosis date, a diagnostician, a diagnostic criterion, a diagnostic classification, and findings 1104. Since the findings 1104 includes not only a section for inputting overall findings but also a section linked with the annotation information processed by the image processing apparatus 102, a user can view the electronic medical record to confirm the contents described as an annotation. Thus, the user can easily confirm text information 1104 written as diagnosis findings, text information 1105 about the annotation corresponding to the basis of the diagnosis, and correspondence between the information and the sample image.

In FIG. 11B, stomach cancer of the cancer classification Japanese code I is selected as the diagnostic criterion. However, the user can easily confirm findings of the diagnostic criterion by selecting another diagnostic criterion from a pull-down menu of the diagnostic criteria. Further, the user can easily confirm the correspondence between the text information 1104 about the diagnosis findings based on the different diagnostic criterion and the sample image by linking the series of operations performed on the electronic medical record and the operation for indicating the annotation described in FIG. 7C.

As described above, a user can easily confirm the correspondence between the text information about the diagnosis findings based on the different diagnostic criterion and the sample image by linking with a system of the electronic medical record.

According to the present exemplary embodiment, not only the contents of an annotation but also the diagnostic criterion information are stored together and the correspondence relation therebetween is prepared as a list at the time of adding the annotation, so that a user can easily discriminate the diagnostic criterion when the annotation is indicated.

In addition, the present exemplary embodiment can easily deal with the update of the diagnostic criterion by updating the contents of a database thereof.

Further, according to the present exemplary embodiment, a warning is issued to the user that an annotation is added based on the different diagnostic criterion, so that the user can avoid adding an annotation based on the different diagnostic criterion which the user does not intend to apply. Furthermore, when the user intentionally adds an annotation based on the different diagnostic criterion, the user can be clearly reminded of the intention.

Furthermore, according to the present exemplary embodiment, by indicating the diagnostic classification correspondence, the user can easily comprehend the correspondence relation, for example, when the user performs diagnosis based on the different diagnostic criterion or when the user confirms the sample diagnosed based on the different diagnostic criterion.

Aspects of the present invention can also be realized by a computer of a system or apparatus (or devices such as a CPU or an MPU) that reads out and executes a program recorded on a memory device to perform the functions of the above-described embodiment, and by a method, the steps of which are performed by a computer of a system or apparatus by, for example, reading out and executing a program recorded on a memory device to perform the functions of the above-described embodiment. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-286782 filed Dec. 27, 2011, which is hereby incorporated by reference herein in its entirety.

What is claimed is:

1. An image processing apparatus comprising:
a data acquisition unit configured to acquire data of a virtual slide image; and
a display control unit configured to display the virtual slide image and a plurality of annotations added to the virtual slide image on a display apparatus,
wherein data pieces of the plurality of annotations include diagnostic criterion information of the plurality of annotations, respectively, and
wherein the display control unit groups at least two of the plurality of annotations based on the diagnostic criterion information, causes display forms of the plurality of annotations to differ from each other based on the diagnostic criterion information, and displays the plurality of annotations on the virtual slide image.

2. The image processing apparatus according to claim 1, further comprising:
a diagnostic criterion information acquisition unit configured to acquire the diagnostic criterion information,
wherein the diagnostic criterion information acquisition unit reads and acquires the diagnostic criterion information from a database.

3. The image processing apparatus according to claim 1, wherein the display control unit displays a warning on the display apparatus, in a case where an annotation according to a second diagnostic criterion different from a first diagnostic criterion is input to the virtual slide image to which an annotation is added according to the first diagnostic criterion.

4. The image processing apparatus according to claim 1, wherein the display control unit displays correspondence between a diagnostic classification according to a first diagnostic criterion and a diagnostic classification according to a second diagnostic criterion different from the first diagnostic criterion, in a case where an annotation according to the second diagnostic criterion is input to a virtual slide image to which an annotation according to the first diagnostic criterion is added.

5. An image processing system including an image processing apparatus capable of processing a virtual slide image and a display apparatus capable of displaying the virtual slide image, comprising:
a data acquisition unit configured to acquire data of the virtual slide image; and
a display control unit configured to display the virtual slide image and a plurality of annotations added to the virtual slide image on the display apparatus,
wherein data pieces of the plurality of annotations include diagnostic criterion information of the plurality of annotations, respectively, and
wherein the display control unit groups at least two of the plurality of annotations based on the diagnostic criterion information, causes display forms of the plurality of annotations to differ from each other based on the diagnostic criterion information, and displays the plurality of annotations on the virtual slide image.

6. An image processing system including an image processing apparatus capable of processing a virtual slide image, a first display apparatus capable of displaying the virtual slide image, and a second display apparatus capable of displaying electronic medical record information, the image processing system comprising:
a data acquisition unit configured to acquire data of the virtual slide image and data of a plurality of annotations added to the virtual slide image;
a first display control unit configured to display the virtual slide image on the first display apparatus; and
a second display control unit configured to display the electronic medical record information on the second display apparatus,
wherein data pieces of the plurality of annotations include diagnostic criterion information of the plurality of annotations, respectively,
wherein the first display control unit groups at least two of the plurality of annotations based on the diagnostic criterion information, causes display forms of the plurality of annotations to differ from each other based on the diagnostic criterion information, and displays the plurality of annotations on the virtual slide image,
wherein the second display control unit displays the plurality of annotations as the electronic medical record information, and
wherein the plurality of annotations displayed on the virtual slide image is linked with the plurality of annotations displayed as the electronic medical record information.

7. A method for processing an image, the method comprising:
causing a computer to acquire data of a virtual slide image; and
causing the computer to display the virtual slide image and a plurality of annotations added to the virtual slide image on a display apparatus,
wherein data pieces of the plurality of annotations include diagnostic criterion information of the plurality of annotations, respectively, and
wherein the displaying groups at least two of the plurality of annotations based on the diagnostic criterion information, causes display forms of the plurality of annotations to differ from each other based on the diagnostic criterion information, and displays the plurality of annotations on the virtual slide image.

8. A computer program stored on a non-transitory computer readable medium, the program causing a computer to perform a method comprising:
acquiring data of a virtual slide image; and
displaying the virtual slide image and a plurality of annotations added to the virtual slide image on a display apparatus,
wherein data pieces of the plurality of annotations include diagnostic criterion information of the plurality of annotations, respectively, and
wherein the displaying groups at least two of the plurality of annotations based on the diagnostic criterion information, causes display forms of the plurality of annotations to differ from each other based on the diagnostic criterion information, and displays the plurality of annotations on the virtual slide image.
